(19) United States
(12) Patent Application Publication
(10) Pub. No.: US 2017/0198229 A1
(43) Pub. Date: Jul. 13, 2017

(54) METHOD AND COMPOSITION FOR IMPROVING THE COMBUSTION OF AVIATION FUELS

(71) Applicant: Afton Chemical Corporation, Richmond, VA (US)

(72) Inventors: Stephen A. Factor, Richmond, VA (US); Zachary John McAfee, Richmond, VA (US)

(73) Assignee: Afton Chemical Corporation, Richmond, VA (US)

(21) Appl. No.: 14/994,199

(22) Filed: Jan. 13, 2016

(51) Int. Cl. C10L 10/10; B64D 37/30; C10L 10/02; C10L 10/04; C10L 1/30; C10L 1/26

(52) U.S. Cl. CPC C10L 10/10; C10L 1/305; C10L 1/2641; C10L 10/02; C10L 10/04; B64D 37/30; C10L 2200/0254; C10L 2200/0268; C10L 2270/04

(57) ABSTRACT

An aviation fuel is formulated with manganese-containing compounds. The composition may include relatively high amounts of manganese up to about 500 mg Mn/l. A manganese-containing additive may reduce the smoke created during the combustion of the aviation fuel. Additionally, the aviation fuel composition may include manganese to improve octane and include a phosphorus-containing scavenger to reduce manganese oxide engine deposits.

This invention relates to substantially lead-free aviation fuel compositions. The invention is further directed to the use of these aviation fuels that also include a manganese additive in order to increase the octane of the fuel and form a reduced amount of smoke during combustion.

### BACKGROUND

For at least regulatory reasons, aviation fuels are well into the process of becoming unleaded fuels. The removal of lead from a fuel, however, has the undesired effect of lowering the knock rating of a fuel. Accordingly, as aviation fuels are in the process of becoming unleaded, the formulation of those fuels must account for the octane reduction from losing lead. The addition of other fuel components is needed.

A common way to improve octane performance is to incorporate into an aviation fuel a high amount of aromatic hydrocarbons. These aromatic hydrocarbons allow the aviation fuel to be unleaded but still meet knock rating requirements. However, the use of significant amounts of aromatic hydrocarbons in the aviation fuel changes the burn efficiency of that fuel and results in increasing formation of smoke during the combustion process. Needless to say, increased amounts of smoke are undesirable in terms of aesthetics and environmental impact. Generally speaking, the higher the amount of aromatic hydrocarbons incorporated into a fuel composition, the higher the amount of smoke that is produced during combustion of that fuel.

Another strategy to improve octane performance is incorporate into an aviation fuel a manganese-containing additive. Manganese additives allow the aviation fuel to be unleaded but still improve the knock rating requirements over an unadditized and unleaded fuel composition. The use of manganese-containing compounds in the aviation fuel may result in the formation of manganese oxide deposits on various engine components. Generally, speaking, the higher the amount of manganese incorporated into a fuel composition, the higher the amount manganese oxide deposits may be formed.

### SUMMARY

Accordingly, it is an object of the present invention to formulate an aviation fuel composition that includes both high aromatic content for octane purposes together with an effective amount of a manganese compound to reduce the smoke created during the combustion of the aviation fuel. Alternatively, the aviation fuel composition may include manganese to improve octane and a scavenger to reduce manganese oxide engine deposits. One such useful scavenger is tricresyl phosphate.

In one example, a substantially unleaded aviation fuel composition comprises from 0 to about 80 volume percent of aviation alkylate. The fuel composition further comprises from about 20-100 volume person of aromatic hydrocarbons. And the fuel composition comprises from about 0.5 to 500 mgMn/l of one or more cyclopentadienyl manganese tricarbonyl compounds. The composition is substantially lead-free, and the composition has a minimum knock value lean rating octane number of at least about 96 as determined by ASTM Test Method D 2700.

In another example, a method reducing the amount of smoke that results from the combustion of an aviation fuel comprises several steps. The method includes providing a spark-ignited aviation engine, and providing a substantially unleaded aviation fuel composition as described above. The method next includes combusting the aviation fuel composition in the engine to create an exhaust plume, wherein the exhaust plume comprises less smoke as compared with a comparable aviation fuel composition that is otherwise identical but for the comparable aviation fuel composition does not comprise essentially any manganese.

In a still further example, a method of reducing manganese oxide engine deposits that result from the combustion of an aviation fuel composition comprising manganese and a phosphorus-containing compound such as tricresyl phosphate comprises several steps. The method includes providing a spark-ignited aviation engine and a substantially unleaded aviation fuel composition as described above. The aviation fuel is then combusted in the engine to create engine deposits, wherein the engine deposits are comprised of less manganese oxide as compared with a comparable aviation fuel composition that is otherwise identical but for the comparable aviation fuel composition does not comprise essentially any phosphorus compound.

### BRIEF DESCRIPTION OF THE DRAWINGS

FIG. 1 is a graph displaying comparative emission opacity performance.

FIG. 2 is a bar graph that illustrates average emission opacity for each of the ten second periods through the first 40 seconds of combustion.

FIG. 3 is a bar graph illustrating comparative time before misfire testing.

### DETAILED DESCRIPTION

The aviation fuel described herein is a lead-free fuel composition that may or may not include a significant aromatic content. As an aviation fuel, the fuel may include aviation alkylates. Specifically, the fuel composition as described herein shall additionally have an aromatic hydrocarbon content of at least 20 percent by volume up to 90 percent. In order to offset the smoke created during the combustion of a high aromatic fuel, 0.5 to 500 mg Mn/l is incorporated in the fuel composition. The resulting fuel has a minimum knock value lean rating octane number of at least about 96 or alternatively at least about 98, or further alternatively at least about 99.5 as determined by ASTM Test Method D 2700. Even fuels with a more conventional ratio of aviation alkylates and aromatic hydrocarbons benefit from the addition of manganese as described to improve the fuel octane number.

Also described herein is a method of reducing the amount of smoke that results from the combustion of a lead-free aviation fuel. An aviation fuel that may include aviation alkylates and about 20 to 90 percent of aromatic hydrocarbons creates an increase in visible smoke and particulate during combustion. By adding about 0.5 to 500 mg Mn/l of one or more cyclopentadienyl manganese tricarbonyl components, the amount of smoke that is created in the exhaust plume is reduced as compared with the same aviation fuel composition that is otherwise identical except that it does not comprise essentially any manganese.

Even in an aviation fuel that may include a conventional aviation fuel composition of aviation alkylates, aromatic hydrocarbons and isopentane, and in another example, by adding about 0.5 to 500 mg Mn/l of one or more cyclopentadienyl manganese tricarbonyl compounds, the octane of the fuel composition is improved to at least an octane number of about 96, or about 98, or alternatively about 99.5. An additive package that includes manganese at the amount of 0.5 to 500 mg Mn/l, or alternatively about 1 to 125 mg Mn/l, or still further alternatively about 36 to 125 mg Mn/l may also include antioxidant and one or more scavenger components. The scavenger component may in one example be tricresyl phosphate (TCP), phosphorus-containing organic oligomers, or DMMP (dimethyl methyl phosphonate). The TCP may be added in an effective amount to scavenge the manganese combustion products. Without being limited to this explanation, it is believed that a compound formed from the combustion of a manganese compound (e.g. MMT) and a phosphorus compound (e.g. TCP) would be a manganese phosphate, Mn₂P₂O₇. In one embodiment, TCP is used in a treat rate that is stoichiometric with the manganese to phosphate ratio. The TCP may be added at a 1:1 treat rate, Mn:P, compared with amount of manganese, or alternatively the TCP may added in the range of about 1:1 up to 1:3 manganese to phosphorus.

When using a manganese compound as an additive in an aviation fuel composition, there can be the formation of a manganese oxide deposit. The formulation that includes the scavengers described herein can substantially reduce the occurrence of any manganese oxide engine deposits.

For the purposes of this application, a fuel composition is described in ASTM 4814 as substantially “lead-free” or “unleaded” if it contains 13 mg of lead or less per liter (or about 50 mg Pb/gal or less) of lead in the fuel. Alternatively, the terms “lead-free” or “unleaded” mean about 7 mg of lead or less per liter of fuel. Still further alternatively, it means an essentially undetectable amount of lead in the fuel composition. In other words, there can be trace amounts of lead in a fuel; however, the fuel is essentially free of any detectable amount of lead. It is to be understood that the fuels are unleaded in the sense that a lead-containing antiknock agent is not deliberately added to the gasoline. Trace amounts of lead due to contamination of equipment or like circumstances are permissible and are not to be deemed excluded from the fuels described herein.

The aviation fuel composition as described herein typically contains aviation alkylate components. Those components may comprise about 10 to 80 volume percent of the fuel. Aromatic hydrocarbons may be incorporated into the fuel to improve the octane rating of the fuel. These aromatic hydrocarbons are incorporated according to one example of the present invention at a rate of about 20 to 90 volume percent of the fuel composition. In another example, the aromatic hydrocarbons are incorporated at a rate of about 40 to 85 volume percent of the fuel composition. And in yet another embodiment the aromatic hydrocarbons are incorporated at a rate of about 50 to 70 volume percent of the fuel composition.

The fuel blend may contain more than about 20 volume percent of aromatic gasoline hydrocarbons, at least a major proportion of which are mononuclear aromatic hydrocarbons such as toluene, xylenes, the mesitylenes, ethyl benzene, etc. Mesitylene is particularly preferred in one embodiment. Other suitable optional gasoline hydrocarbon components that can be used in formulating the aviation fuels described herein include isopentane, light hydrocracked gasoline fractions, and/or Cu gasoline isomerate.

Cyclopentadienyl manganese tricarbonyl compounds which can be used in the practice of the fuels herein include cyclopentadienyl manganese tricarbonyl, methylcyclopentadienyl manganese tricarbonyl, dimethylcyclopentadienyl manganese tricarbonyl, trimethylcyclopentadienyl manganese tricarbonyl, tetramethylcyclopentadienyl manganese tricarbonyl, pentamethylcyclopentadienyl manganese tricarbonyl, ethylcyclopentadienyl manganese tricarbonyl, diethylcyclopentadienyl manganese tricarbonyl, propylcyclopentadienyl manganese tricarbonyl, isopropylcyclopentadienyl manganese tricarbonyl, tertbutylcyclopentadienyl manganese tricarbonyl, octylcyclopentadienyl manganese tricarbonyl, dodecylcyclopentadienyl manganese tricarbonyl, ethylmethylcyclopentadienyl manganese tricarbonyl, indenyl manganese tricarbonyl, and the like, including mixtures of two or more such compounds. Preferred are the cyclopentadienyl manganese tricarbonyls which are liquid at room temperature such as methylcyclopentadienyl manganese tricarbonyl, ethylcyclopentadienyl manganese tricarbonyl, liquid mixtures of cyclopentadienyl manganese tricarbonyl and methylcyclopentadienyl manganese tricarbonyl, mixtures of methylcyclopentadienyl manganese tricarbonyl and ethylcyclopentadienyl manganese tricarbonyl, etc. The aviation fuels of this invention will contain an amount of one or more of the foregoing cyclopentadienyl manganese tricarbonyl compounds sufficient to provide the requisite octane number and valve seat wear performance characteristics.

Other components which can be employed, and under certain circumstances are preferably employed, include dyes which do not contribute to excessive induction system deposits. Typical dyes which can be employed are 1,4-dialkylaminoanthraquinone, p-diethylaminoazobenzene (Color Index No. 11020) or Color Index Solvent Yellow No. 107, methyl derivatives of azobenzene-4-azo-2-naphthol (methyl derivatives of Color Index No. 26105), alkyl derivatives of azobenzene-4-azo-2-naphthol, or equivalent materials. The amounts used should, wherever possible, conform to the limits specified in ASTM Specification D 910-90.

Fuel system icing inhibitors may also be included in the fuels herein. Preferred are ethylene glycol monomethyl ether and isopropyl alcohol, although materials giving equivalent performance may be considered acceptable for use. Amounts used should, wherever possible, conform to the limits referred to in ASTM Specification D 910-90.

### Example 1

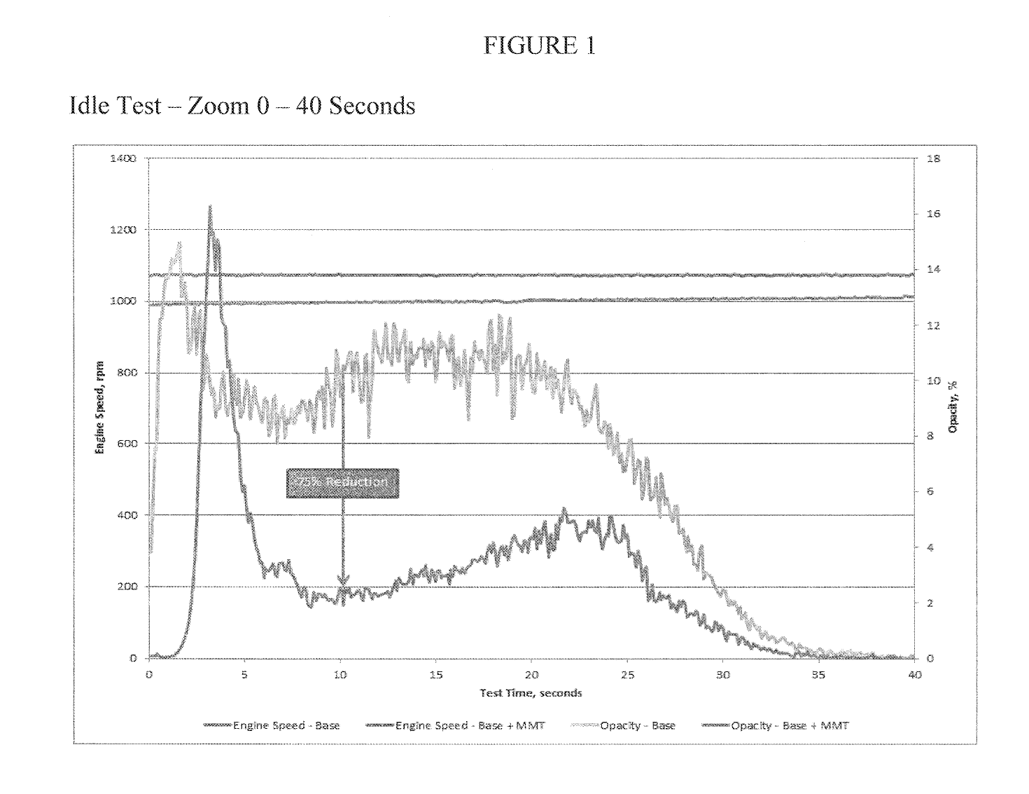

In order to demonstrate an exemplary aviation fuel and the corresponding reduction in smoke formation from combustion of that fuel, a spark ignition engine is used. The spark ignition engine is actually an automotive engine for a 1994 Chevrolet Silverado. This automobile engine was unable to run on pure aviation fuel, so a mixture of 50% EEE automotive gasoline and 50% aviation fuel was used. The aviation fuel blend base line was 83% mesitylene and 17% isopentane. An idle test was run and the opacity of the emissions was measured. In the test, as shown in FIG. 1, the opacity leveled off to approximately zero at shortly before 40 seconds of operation for both the control fuel composition (no Mn added) and the control fuel mixed with a manganese compound. The opacity of the control base fuel was much higher than the opacity of the base fuel mixed with a manganese component, including a reduction in opacity of up to at least about 75% as shown. The reduction in opacity may alternatively be about 10%-60%, or still further alternatively about 25%-50%, as also shown. Specifically, the manganese component that was mixed in was HiTEC® 3000, which results in a manganese mg Mn/l treatment of 18 milligrams manganese per liter of fuel. It is noted that the smoke production is highly dependent on air/fuel ratio. Furthermore, the particular emissions control unit for the test engine is able to adapt the air/fuel ratio within about 35 seconds to remove the smoke formation caused from the combustion of the fuel.

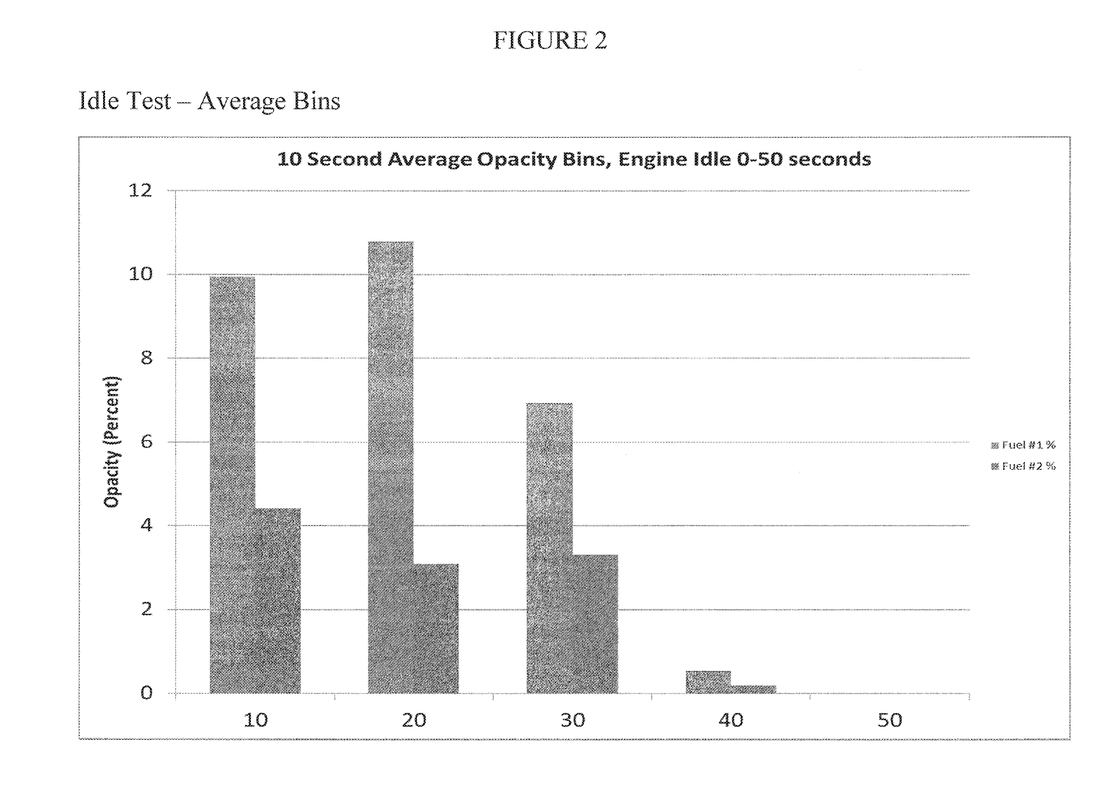

Finally, referring to FIG. 2, the average opacity for each of the 10 second periods through the first 40 seconds of combustion demonstrates, in each case, the opacity of the untreated fuel is significantly greater than the opacity of the fuel that includes the manganese additive.

### Example 2

In another example, an unleaded aviation fuel was additized with an additive package to improve the octane number of the fuel. The base, unleaded aviation fuel was comprised of aviation alkylates 72%, aromatic hydrocarbons 20%, isopentane 8%, had an octance number of 93. An additive package comprising a treat rate of 125 mg Mn/1 and 2.12 g/gal of tricresylphosphate (TCP) was added to the base fuel to increase the octane number to %.

It was discovered that the resulting amounts of combustion engine deposits containing manganese oxides were greatly reduced due to the phosphorus compound addition. Testing was performed on a Honda Accord on a chassis dynamometer. The vehicles On Board Diagnostics (OBD) system was used to monitor spark plug misfire. The vehicle was run on comparative fuel formulations until the OBD system indicated a spark plug misfire. Candidate formulations containing MMT and the TCP scavenger had significantly longer time to misfire than candidate formulations containing MMT alone.

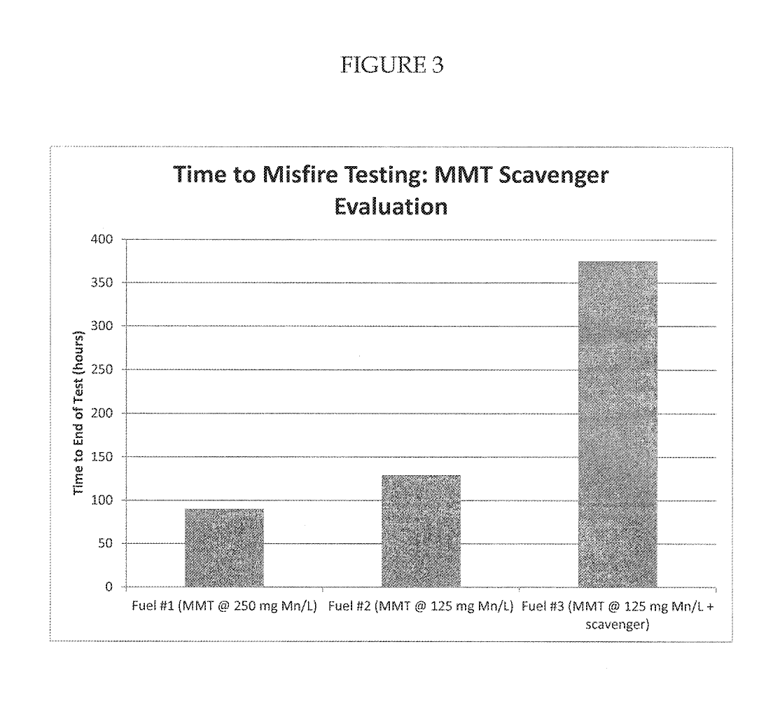

As shown in FIG. 3, fuels #1 and #2 were run on test vehicles and included 250 and 125 mg Mn/l respectfully. Fuel #3 included both 125 mg Mn/l and a scavenger and the improved performance is readily visible on the chart of FIG. 3.

Thus, Example 2 illustrates a method of delaying or eliminating spark plug misfire caused by accumulation of manganese oxide engine deposits that result from the combustion of an aviation fuel composition comprising manganese, the method comprising the steps of:
providing a spark-ignited aviation engine;
providing a substantially unleaded aviation fuel composition comprising:

(a) from about 10 to about 80 volume percent of aviation alkylate;

(b) from about 20 to about 90 volume percent of aromatic hydrocarbons;

(c) from about 0.5 to 500 mg Mn/l of one or more cyclopentadienyl manganese tricarbonyl; and

(d) an effective amount of phosphorus compound such as tricresyl phosphate;
wherein the composition is substantially lead-free, and the composition has a minimum knock value lean rating octane number of at least about 96 as determined by ASTM Test Method D2700;
combusting the aviation fuel composition in the engine to create engine deposits;
wherein the engine deposits are comprised of less manganese oxide as compared with deposits produced from the combustion of a comparable aviation fuel composition that is otherwise identical but for the comparable aviation fuel composition does not comprise essentially any phosphorus-containing material such as tricresyl phosphate.

Other embodiments of the present disclosure will be apparent to those skilled in the art from consideration of the specification and practice of the disclosure disclosed herein. As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the disclosure being indicated by the following claims.

That which is claimed is:

1. A substantially unleaded aviation fuel composition comprising:
(a) from about 10 to about 80 volume percent of aviation alkylate;
(b) from about 20 to about 90 volume percent of aromatic hydrocarbons; and
(c) from about 0.5 to 500 mg Mn/l of one or more cyclopentadienyl manganese tricarbonyl;
wherein the composition is substantially lead-free, and the composition has a minimum knock value lean rating octane number of at least about 96 as determined by ASTM Test Method D 2700.

2. An aviation fuel composition as described in claim 1, comprising about 30 to 90 volume percent of aromatic hydrocarbons.

3. An aviation fuel composition as described in claim 1, comprising about 50 to 90 volume percent of aromatic hydrocarbons.

4. An aviation fuel composition as described in claim 1, wherein substantially lead-free is 13 mg of lead or less per liter of fuel.

5. An aviation fuel composition as described in claim 1, wherein substantially lead-free is about 7 mg of lead or less per liter of fuel.

6. An aviation fuel composition as described in claim 1, wherein substantially lead-free is an essentially undetectable amount of lead in the fuel composition.

7. An aviation fuel composition as described in claim 1, wherein the cyclopentadienyl manganese tricarbonyl is selected from the group consisting of cyclopentadienyl manganese tricarbonyl, methylcyclopentadienyl manganese tricarbonyl, dimethylcyclopentadienyl manganese tricarbonyl, trimethylcyclopentadienyl manganese tricarbonyl, tetramethylcyclopentadienyl manganese tricarbonyl, pentamethylcyclopentadienyl manganese tricarbonyl, ethylcyclopentadienyl manganese tricarbonyl, diethylcyclopentadienyl manganese tricarbonyl, propylcyclopentadienyl manganese tricarbonyl, isopropylcyclopentadienyl manganese tricarbonyl, tertbutylcyclopentadienyl manganese tricarbonyl, octylcyclopentadienyl manganese tricarbonyl, dodecylcyclopentadienyl manganese tricarbonyl, ethylmethylcyclopentadienyl manganese tricarbonyl, indenyl manganese tricarbonyl, and the like, including mixtures of two or more such compounds.

8. An aviation fuel composition as described in claim 1, wherein the cyclopentadienyl manganese tricarbonyl comprises methylcyclopentadienyl manganese tricarbonyl.

9. An aviation fuel composition as described in claim 1, wherein the fuel composition comprises about one to 125 mg Mn/l.

10. An aviation fuel composition as described in claim 1, wherein the fuel composition comprises about 36 to 125 mg Mn/l.

11. An aviation fuel composition as described in claim 1, wherein the composition has a minimum knock value lean rating octane number of at least about 98 as determined by ASTM Test Method D 2700.

12. An aviation fuel composition as described in claim 1, wherein the aromatic hydrocarbons are selected from the group consisting of toluene, xylenes, and mesitylenes.

13. An aviation fuel composition as described in claim 1, wherein further comprising about five to about twenty volume percent of isopentane.

14. An aviation fuel composition as described in claim 1, further comprising (d) a phosphorus compound.

15. An aviation fuel composition as described in claim 14, wherein the phosphorus compound comprises tricresyl phosphate.

16. An aviation fuel composition as described in claim 14, wherein the phosphorus compound is present in an amount to be a stoichiometric ratio of Mn to P of from about 1:1 to 1:3.

17. An aviation fuel composition as described in claim 14, wherein the fuel composition comprises about 72% of aviation alkylates, about 20% of aromatic hydrocarbons, about 8% of isopentane, a treat rate of 125 mg Mn/l and 2.12 g/gal tricresyl phosphate.

18. A substantially unleaded aviation fuel composition comprising:
(a) from about 10 to about 80 volume percent of aviation alkylate;
(b) from about 20 to about 90 volume percent of aromatic hydrocarbons;
(c) from about 125 to 500 mg Mn/l of one or more cyclopentadienyl manganese tricarbonyl; and
(d) a phosphorus compound;
wherein the composition is substantially lead-free, and the composition has a minimum knock value lean rating octane number of at least about 96 as determined by ASTM Test Method D 2700.

19. An aviation fuel composition as described in claim 18, wherein substantially lead-free is 13 mg of lead or less per liter of fuel.

20. An aviation fuel composition as described in claim 18, wherein substantially lead-free is about 7 mg of lead or less per liter of fuel.

21. An aviation fuel composition as described in claim 18, wherein substantially lead-free is an essentially undetectable amount of lead in the fuel composition.

22. An aviation fuel composition as described in claim 18, wherein the cyclopentadienyl manganese tricarbonyl is selected from the group consisting of cyclopentadienyl manganese tricarbonyl, methylcyclopentadienyl manganese tricarbonyl, dimethylcyclopentadienyl manganese tricarbonyl, trimethylcyclopentadienyl manganese tricarbonyl, tetramethylcyclopentadienyl manganese tricarbonyl, pentamethylcyclopentadienyl manganese tricarbonyl, ethylcyclopentadienyl manganese tricarbonyl, diethylcyclopentadienyl manganese tricarbonyl, propylcyclopentadienyl manganese tricarbonyl, isopropylcyclopentadienyl manganese tricarbonyl, tertbutylcyclopentadienyl manganese tricarbonyl, octylcyclopentadienyl manganese tricarbonyl, dodecylcyclopentadienyl manganese tricarbonyl, ethylmethylcyclopentadienyl manganese tricarbonyl, indenyl manganese tricarbonyl, and the like, including mixtures of two or more such compounds.

23. An aviation fuel composition as described in claim 18, wherein the cyclopentadienyl manganese tricarbonyl comprises methylcyclopentadienyl manganese tricarbonyl.

24. An aviation fuel composition as described in claim 18, wherein the phosphorus compound comprises tricresyl phosphate.

25. An aviation fuel composition as described in claim 18, wherein the composition has a minimum knock value lean rating octane number of at least about 98 as determined by ASTM Test Method D 2700.

26. An aviation fuel composition as described in claim 18, wherein the aromatic hydrocarbons are selected from the group consisting of toluene, xylenes, and mesitylenes.

27. A method of reducing the amount of smoke that results from the combustion of an aviation fuel composition in a spark-ignited fuel engine comprising the steps of:
providing a substantially unleaded aviation fuel composition comprising:
(a) from about 10 to about 80 volume percent of aviation alkylate;
(b) from about 20 to 90 volume percent of aromatic hydrocarbons; and
(c) from about 0.5 to 500 mg Mn/l of one or more cyclopentadienyl manganese tricarbonyl;
wherein the composition is substantially lead-free, and the composition has a minimum knock value lean rating octane number of at least about 96 as determined by ASTM Test Method D 2700;
combusting the aviation fuel composition in an engine to create an exhaust plume;
wherein the exhaust plume comprises less smoke as compared with a comparable aviation fuel composition that is otherwise identical but for the comparable aviation fuel composition does not comprise essentially any manganese.

28. The method of claim 27, wherein the reducing of the amount of smoke that results from the combustion of an aviation fuel composition is measured by the comparative opacity of the exhaust plumes generated by the combustion of the same aviation fuel composition with and then without any manganese.

29. The method of claim 28, wherein the exhaust plume opacity is reduced by at least 75% by the addition of the manganese.

30. The method of claim 28, wherein the exhaust plume opacity is reduced by about 10% to 60% by the addition of the manganese.

31. The method of claim 28, wherein the exhaust plume opacity is reduced by about 25% to 50% by the addition of the manganese.

32. A method of reducing manganese oxide engine deposits that result from the combustion of an aviation fuel composition comprising manganese in a spark-ignited aviation engine, the method comprising the steps of:
providing a substantially unleaded aviation fuel composition comprising:
(a) from about 10 to about 80 volume percent of aviation alkylate;
(b) from about 20 to 100 volume percent of aromatic hydrocarbons;
(c) from about 0.5 to 500 mg Mn/l of one or more cyclopentadienyl manganese tricarbonyl; and
(d) an effective amount of a phosphorus compound;
wherein the composition is substantially lead-free, and the composition has a minimum knock value lean rating octane number of at least about 96 as determined by ASTM Test Method D2700;
combusting the aviation fuel composition in an engine to create engine deposits;
wherein the engine deposits are comprised of less manganese oxide as compared with a comparable aviation fuel composition that is otherwise identical but for the comparable aviation fuel composition does not comprise essentially any a phosphorus compound.

33. A method of delaying or eliminating spark plug misfire caused by accumulation of manganese oxide engine deposits that result from the combustion of an aviation fuel composition in a spark-ignited aviation engine comprising manganese, the method comprising the steps of:
providing a substantially unleaded aviation fuel composition comprising:
(a) from about 10 to about 80 volume percent of aviation alkylate;
(b) from about 10 to 100 volume percent of aromatic hydrocarbons;
(c) from about 0.5 to 500 mg Mn/l of one or more cyclopentadienyl manganese tricarbonyl; and
(d) an effective amount of a phosphorus compound;
wherein the composition is substantially lead-free, and the composition has a minimum knock value lean rating octane number of at least about 96 as determined by ASTM Test Method D2700;
combusting the aviation fuel composition in an engine to create engine deposits;
wherein the time to the start of spark plug misfire is delayed as compared with a comparable aviation fuel composition that is otherwise identical but for the comparable aviation fuel composition does not comprise essentially any phosphorus-containing material.
